(19) United States
(12) Patent Application Publication
(10) Pub. No.: US 2025/0362506 A1
(43) Pub. Date: Nov. 27, 2025

(54) DISPLAY MODULE, AND A WEARABLE DISPLAY DEVICE

(71) Applicants: Asphetek Solution (Chengdu) Ltd., Chengdu (CN); ADVANCED OPTOELECTRONIC TECHNOLOGY, INC., Hsinchu County (TW); Asphetek Solution Inc., Hsinchu (TW)

(72) Inventors: I-MING CHENG, Hsinchu (TW); CHANG-HO CHEN, Hsinchu (TW); CHUNG-WU LIU, Hsinchu (TW); SHIUE-LUNG CHEN, Hsinchu (TW)

(21) Appl. No.: 18/989,218

(22) Filed: Dec. 20, 2024

(30) Foreign Application Priority Data
May 23, 2024 (CN) 202410648796.5

(51) Int. Cl. G02B 27/01

(52) U.S. Cl. CPC G02B 27/0172; G02B 2027/0178

(57) ABSTRACT

This application provides a display module and a wearable display device, the display module comprises a light emitting module and a conducting module. The light emitting module comprises a display assembly, a first optical waveguide, and a polarizer arranged in sequence in a first direction, the light emitting module further comprises a light emitting unit, the light emitting unit is configured to emit a first light to the first optical waveguide; the first light is transmitted to the display assembly through the first optical waveguide, the display assembly is configured to reflect the first light to form a second light, and the second light passes through the first optical waveguide and the polarizer to form a third light. The conducting module comprises a second optical waveguide. The second optical waveguide is configured to receive the third light and guide the third light to emit the second optical waveguide.

### FIELD

The present disclosure relates to field of image display technology, and in particular to a display module, and a wearable display device.

### BACKGROUND

Wearable display devices, such as AR (Augmented Reality) glasses, are generally equipped with polarizing beam splitter (PBS). The PBS is configured to split lights projected from multiple directions and then collimate the lights, the collimated lights are projected to a display and then transmitted by an optical waveguide to form an AR image, resulting in a larger volume of the AR glasses.

Thus, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows a schematic diagram of a display module of a present application in an embodiment.

FIG. 2 shows a structure diagram of a first optical waveguide of the display module of a present application in an embodiment.

FIG. 3 shows a structure diagram of a display assembly of the display module of a present application in an embodiment.

FIG. 4 shows a structure diagram of a light adjustment assembly of the display module of a present application in an embodiment.

FIG. 5 shows a structure diagram of a second optical waveguide of the display module of a present application in an embodiment.

FIG. 6 shows a structure diagram of an eye-tracking assembly of the display module of a present application in an embodiment.

FIG. 7 shows a schematic diagram of a structure of a wearable display device of a present application in an embodiment.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it in one embodiment indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein includes any and all combinations of one or more of associated listed items.

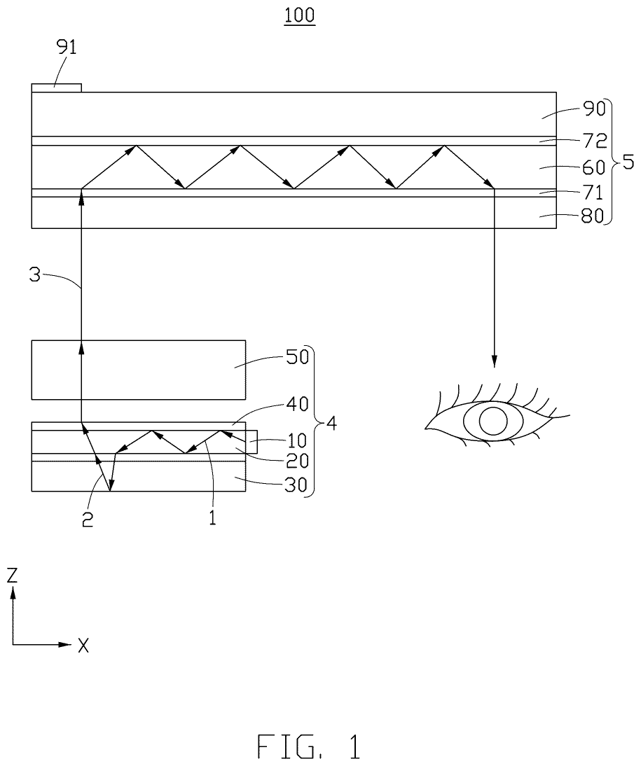

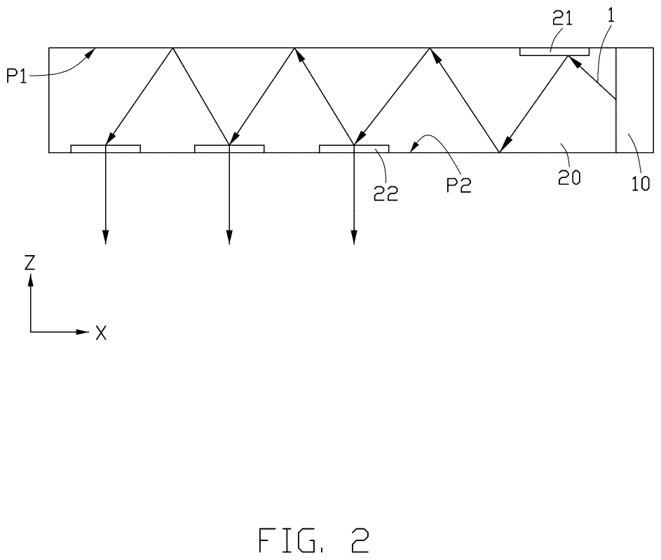

Referring to FIG. 1 to FIG. 2, in one embodiment, the display module 100 includes a light emitting module 4 and a conducting module 5. The display module 100 may be applied in AR (Augmented Reality) glasses, smart watches and other devices to display a desired image. For a convenience of a subsequent description, a direction of a thickness of the display module 100 is parallel to a first direction Z. A direction of a length of the display module 100 is parallel to a second direction X. The first direction Z intersects the second direction X. In other embodiments, the second direction X is perpendicular to the first direction Z.

The light emitting module 4 includes a display assembly 30, a first optical waveguide 20 and a polarizer 40. The display assembly 30, the first optical waveguide 20, and the polarizer 40 are arranged in sequence in the first direction Z. The light emitting module 4 further includes a light emitting unit 10. In the second direction X, the light emitting unit 10 is arranged on one side of the first optical waveguide 20 for emitting a first light 1 to the first optical waveguide 20. The first light 1 is transmitted by the first optical waveguide 20 to the display assembly 30, the display assembly 30 is configured to reflect the first light 1 to form a second light 2. The second light 2 passes through the first optical waveguide 20 and the polarizer 40 to form a third light 3. The conducting module 5 includes a second optical waveguide 60. In the first direction Z, the second optical waveguide 60 is arranged on a side of the light emitting module 4 for receiving the third light 3 and guiding the third light 3 to be emitted out of the second optical waveguide 60.

Thus, in the applied display module 100, the light emitting unit 10 is arranged on one side of the first optical waveguide 20 along the second direction X. The first light emitted by the light emitting unit 10 is transmitted in the first optical waveguide 20 along the second direction X. The light emitting unit 10 can take advantage of a space in a length direction of the display module 100 for installation and light transmission, avoiding an excessive use of the display module 100 to install the light emitting unit 10 and transmit light in the space in the first direction Z, thereby reducing a thickness of the entire display module 100.

Referring to FIG. 1 to FIG. 2, in one embodiment, the first optical waveguide defines a first surface P1 and a second surface P2. The first surface P1 and the second surface P2 are opposite to each other along the first direction Z. A space defined between the first surface P1 and the second surface P2 is less than 1 mm. The first surface P1 is arranged on a side of the first optical waveguide 20 near the polarizer 40. The second surface P2 is arranged on a side of the first optical waveguide 20 near the display assembly 30. The first surface P1 is parallel to the second surface P2.

When the first light 1 is emitted into the first optical waveguide 20, a part of lights in the first light 1 is reflected by the first surface P1 and then passes through the second surface P2. When the part of lights in the first light 1 passes through the second surface P2, the part of lights in the first light 1 is emitted to the display assembly 30. The display assembly 30 processes the first light 1 that is directed into it to form a second light 2 that presents a specific image.

Furthermore, the first optical waveguide 20 includes a coupled structure 21 and one or more decoupled structure 22. The coupled structure 21 is arranged on a side of the first optical waveguide 20 near the light emitting unit 10, the first light 1 in the first optical waveguide 20 can be totally reflected on the first surface P1. The light emitting unit 10 may be a three-color LED lamp. The first light 1 emitted by the three-color LED lamp 1 includes red light, green light and blue light. A beam angle of the first light 1 emitted by the light emitting unit 10 is 120°.

The coupled structure 21 may be a mirror, a prism, a relief grating, etc., so that a part of the first light 1 directed at the coupled structure 21 can be directed to the first surface P1 through a refraction or a reflection. An incidence angle of the first light 1 towards the first surface P1 satisfies a total reflection condition of the first surface P1, so that the first light 1 is reflected from the first surface P1 and then reflects to the second surface P2. In condition of the first surface P1 is parallel to the second surface P2, the first light 1 directed towards the second surface P2 is totally reflected on the second surface P2 and continues to be directed towards the first surface P1 and continues above actions, thus achieving a diffraction of the first light 1 along the second direction X through a multiple total reflections of the first light 1 on the first surface P1 and the second surface P2.

The coupled structure 21 can also be arranged on the first surface P1. When the first light 1 emitted by the light emitting unit 10 is directed to the coupled structure 21 of the first surface P1, the first light 1 is refracted and/or reflected by the coupled structure 21 times, then the first light 1 is re-emitted to the second surface P2 and satisfies a total reflection condition of the second surface P2. The first light 1 is totally reflected on the second surface P2 and then directed to the first surface P1 and then continues to be totally reflected.

A number of the decoupled structures 22 is multiple, along the second direction X, the multiple decoupled structures 22 are arranged sequentially on the second surface P2. The decoupled structure 22 is configured to receive the first light 1 occurred a total reflection and guide the first light 1 to the display assembly 30. The decoupled structure 22 may be a grating structure, the grating structure can be a binary grating, a two-dimensional grating or an inclined grating. When the first light 1 is totally reflected on the first surface P1 and then emitted to the second surface P2, the first light 1 is emitted to the coupled structure 22 arranged on the second surface P2. Then, a part of the first light 1 is guided by the decoupled structure 22 through the second surface P2 and emitted to the display assembly 30, and the other part of the first light 1 continues to be totally reflected and then emitted to the first surface P1.

A number of the decoupled structures 22 is multiple. The multiple decoupled structures 22 are set at intervals in the second direction X, making that the first light 1 can be emitted in different areas on the second surface P2 during a forward diffraction process in the second direction X, result in an increase of a coverage area on the second direction X after the first light 1 is emitted by the first optical waveguide 20.

When the red light, green light, and blue light in the first light 1 are transmitted in the first optical waveguide 20, the red light, green light, and blue light in the first light 1 are totally reflected on the first surface P1 and the second surface P2 for many times, which can mix the red light, green light, and blue light and ensure that the first light 1 emitted from each decoupled structure 22 includes the red light, green light, and blue light. Then, the mixed first light 1 is directed to the display assembly 30.

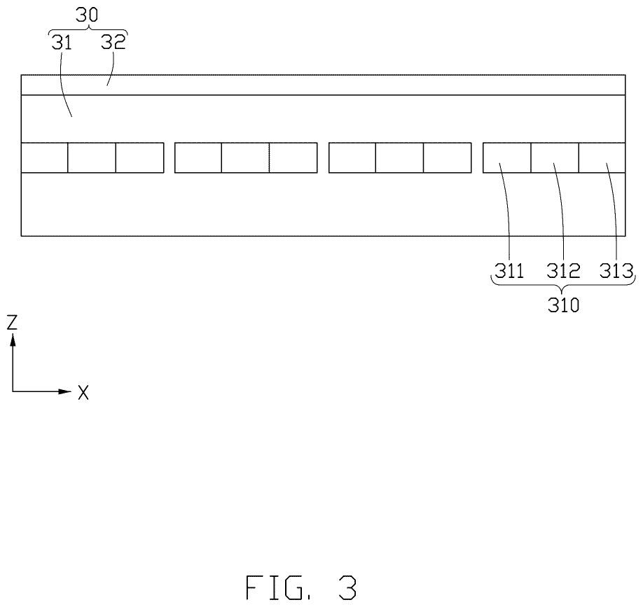

Referring to FIG. 1 to FIG. 3, in one embodiment, the display assembly 30 includes a reflective display 31 and a pattern unit 32. The reflective display 31 and the pattern unit 32 are arranged in sequence along the first direction Z. The pattern unit 32 is arranged on a side of the reflective display 31 near the first optical waveguide 20. The reflective display 31 is configured to reflect the first light 1 to form the second light 2. The pattern unit 32 is configured to be passed through by a part of the second light 2.

The reflective display 31 includes a plurality of trichromatic liquid crystal units 310, the plurality of trichromatic liquid crystal units 310 is distributed in array. Each of the plurality of trichromatic liquid crystal units 310 includes a red liquid crystal unit 311, a green liquid crystal unit 312, and a blue liquid crystal unit 313 arranged in sequence. When the first light 1 composed of a mixture of the red light, the green light, and the blue light passes through the trichromatic liquid crystal unit 310, the trichromatic liquid crystal unit 310 can be controlled to change a state of the trichromatic liquid crystal unit 310 to adjust colors of the first light 1 passing through the current trichromatic liquid crystal unit 310, so as to facilitate a subsequent display of images composed of different colors.

Furthermore, a required pattern is formed on the pattern unit 32. The pattern unit 32 can be formed by means of a filter or a hollow design. The pattern allows only part of the color-adjusted first light 1 to continue through the pattern unit 32, and the remaining part of the first light 1 is blocked, so that the second light 2 passing through the pattern unit 32 can later form a specific color pattern.

A side of the second surface P2 near the first surface P1 is configured to reflect light, and a side of the second surface P2 away from the first surface P1 is configured to allow lights pass through the second surface P2, so that the light incident from the side of the second surface P2 away from the first surface P1 can pass through the second surface P2. When the second light 2 passing through the pattern unit 32 is directed towards the first optical waveguide 20, the second light 2 is directed into the first optical waveguide 20 from a side of the second surface P2 away from the first surface P1. Then, the second light 2 will pass directly through the second surface P2 and then exit from the first surface P1. The second light 2 passes through the first optical waveguide 20 and continues through the polarizer 40. The polarizer 40 filters the second light 2, allowing lights in specific directions of the second light 2 to pass through, thereby improving a sharpness of a subsequent imaging.

The reflective display 31, the pattern unit 32, the first optical waveguide 20, and the polarizer 40 are stacked sequentially. Any two adjacent elements are connected to each other so that the reflective display 31, the pattern unit 32, the first optical waveguide 20, and the polarizer 40 are used as a module for operations.

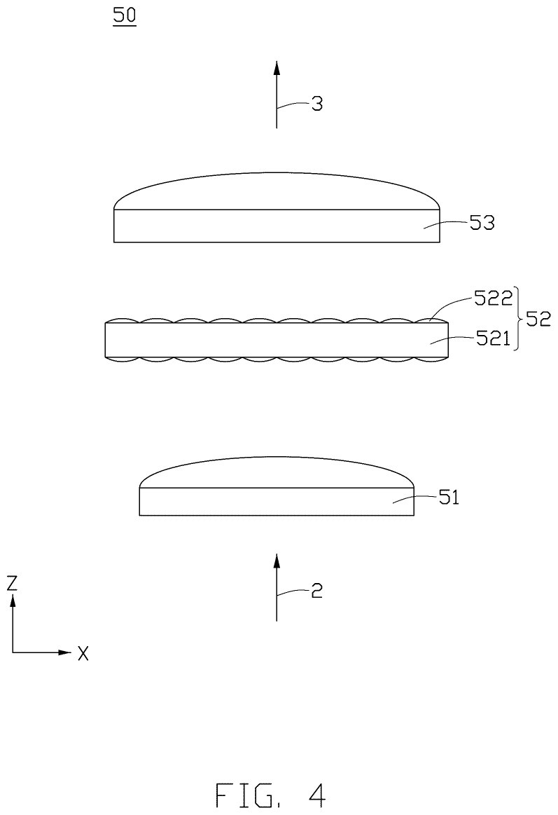

Referring to FIG. 1 to FIG. 4, in one embodiment, the light emitting module 4 further includes a light adjustment assembly 50. The light adjustment assembly 50 is arranged between the polarizer 40 and the second optical waveguide 60 along the first direction Z. The light adjustment assembly 50 includes a collimating lens 51, a light homogenizing lens 52 and a relay lens 53 arranged in sequence. The collimating lens 51 is located on a side of the relay lens 53 near the polarizer 40.

When the second light 2 passes through the polarizer 40, the second light 2 enters into the collimating lens 51. The collimating lens 51 adjusts the second light 2 so that a beam angle of the second light 2 is less than 10°. The collimating lens 51 can adopt a double convex structure or a flat convex structure. In particular, the polarizer 40 and the collimating lens 51 are spaced apart, and a space between the polarizer 40 and the collimating lens 51 is less than 0.65 mm.

The light homogenizing lens 52 includes a main body 521 and two micro lens structures 522. Along the first direction Z, two micro lens structures 522 are arranged on two opposite sides of the main body 521 in an array. Along the first direction Z, surfaces on the two opposite sides of the body part 521 are flat. The micro lens structure 522 is formed by an array of several hemispherical lens structures. When the second light 2 calibrated by the collimating lens 51 enters and leaves the light homogenizing lens 52, the second light 2 is reflected several times at the micro lens structure 522, thereby improving a uniformity of the second light 2 emitted by the light homogenizing lens 52. In addition to above structures, the light homogenizing lens 52 can also be used in a form of a lens of other structures or a combination of several lenses, so as to ensure that the light homogenizing lens 52 achieves a role of adjusting the uniformity of the second light 2 to ensure a brightness and the uniformity of a subsequent imaging.

The relay lens 53 can be a lens of a flat convex structure. Along the first direction Z, the relay lens 53 includes a convex surface and a plane. When the second light 2 is emitted into the plane of the relay lens 53, the second light 2 is refracted through a curved surface, so that the second light 2 diffuses and forms a third light 3, thereby amplifying a subsequent image. The relay lens 53 may be other structures of lenses or several lens combinations to achieve a magnification of the image.

The collimating lens 51, the light homogenizing lens 52, and the relay lens 53 are arranged at intervals from each other. A space defined between any two of above lenses can be adjusted adaptively according to parameters such as a curvature of the lens. A distance between the polarizer 40 and the relay lens 53 is less than 1 mm. The relay lens 53 is spaced apart from the conducting module 5, a distance between the relay lens 53 and the conducting module 5 is less than or equal to 1 mm.

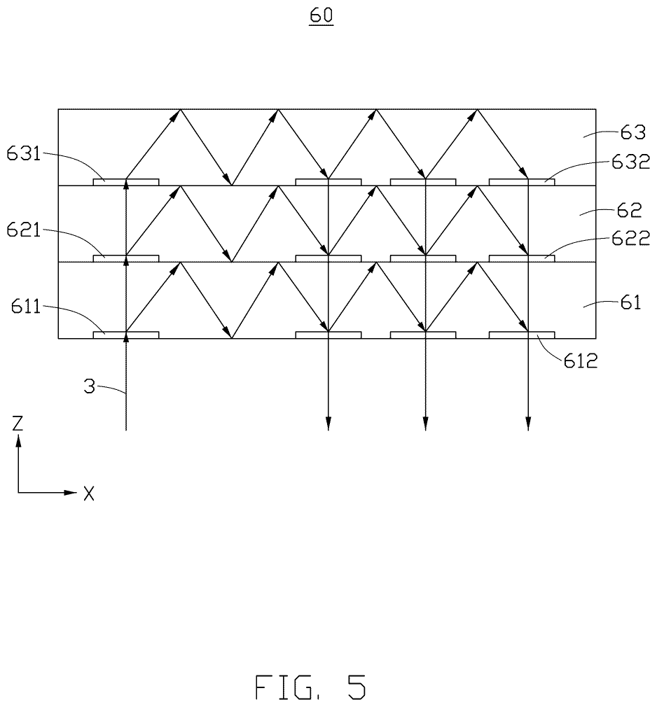

Referring to FIG. 1, FIG. 2 and FIG. 5, in one embodiment, along the second direction X, an extension length of the second optical waveguide 60 is greater than an extension length of the light emitting module 4. The light emitting module 4 corresponds roughly to a left region of the second optical waveguide 60. When the third light 3 is emitted at the second optical waveguide 60 by the light emitting module 4, the third light 3 is diffracted to a right in the second direction X in the second optical waveguide 60. When the third light 3 is emitted at the right region of the second optical waveguide 60, the third light 3 is transmitted to an eyeball.

The second optical waveguide 60 includes a red waveguide layer 61, a green waveguide layer 62, and a blue waveguide layer 63 arranged in sequence in the first direction Z. The red waveguide layer 61 is located on a side of the blue waveguide layer 63 near the light emitting module 4. The red waveguide layer 61 is adapted to a wavelength of the red light. The red waveguide layer 61 is configured to receive and transmit the red light in the third light 3. The green waveguide layer 62 is adapted to a wavelength of the green light. The green waveguide layer 62 is configured to receive and transmit the green light in the third light 3. The blue waveguide layer 63 is adapted to the wavelength of the blue light. The blue waveguide layer 63 is configured to receive and transmit the blue light in the third light 3.

The red waveguide layer 61 includes a red coupled module 611 and one or more red decoupled module 612. A principle and a working mode of the red coupled module 611 and the red decoupled module 612 are the same as the coupled structure 21 and the decoupled structure 22 of the first optical waveguide 20. The red coupled module 611 and the red decoupled module 612 are arranged on a side of the red waveguide layer 61 near the light emitting module 4, so that the red light of the third light 3 entering the red waveguide layer 61 can be totally reflected in the red waveguide layer 61, and finally be emitted out of the red waveguide layer 61 from the red coupled module 612.

The green waveguide layer 62 defines a green coupled module 621 and one or more green decoupled module 622. A principle and a working mode of the green coupled module 621 and the green decoupled module 622 are the same as the coupled structure 21 and the decoupled structure 22 of the first optical waveguide 20. The green coupled module 621 and the green decoupled module 622 are arranged on a side of the green waveguide layer 62 near the light emitting module 4, so that the green light of the third light 3 entering the green waveguide layer 62 can be totally reflected in the green waveguide layer 62, and finally be emitted out of the green waveguide layer 62 from the green coupled module 622.

The blue waveguide layer 63 defines a blue coupled module 631 and one or more blue decoupled module 632. A principle and a working mode of the blue coupled module 631 and the blue decoupled module 632 are the same as the coupled structure 21 and the decoupled structure 22 of the first optical waveguide 20. The blue coupled module 631 and the blue decoupled module 632 are arranged on a side of the blue waveguide layer 63 near the light emitting module 4, so that the blue light of the third light 3 entering the blue waveguide layer 63 can be totally reflected in the blue waveguide layer 63, and finally be emitted out of the blue waveguide layer 63 from the blue coupled module 632.

Decoupled modules arranged in each waveguide layer of the second optical waveguide 60 can be set to multiple. The multiple decoupled modules are arranged sequentially along the second direction X. In addition, the decoupled modules arranged in each waveguide layer of the second optical waveguide 60 can be defined on a same side or opposite sides of the waveguide layer with the coupled modules.

Three sets of the third light 3 emitted from the red decoupled module 612, the green decoupled module 622, and the blue decoupled module 632 are arranged parallel to each other. The three sets of the third light 3 can be combined with each other to form a color image to be captured by eyes.

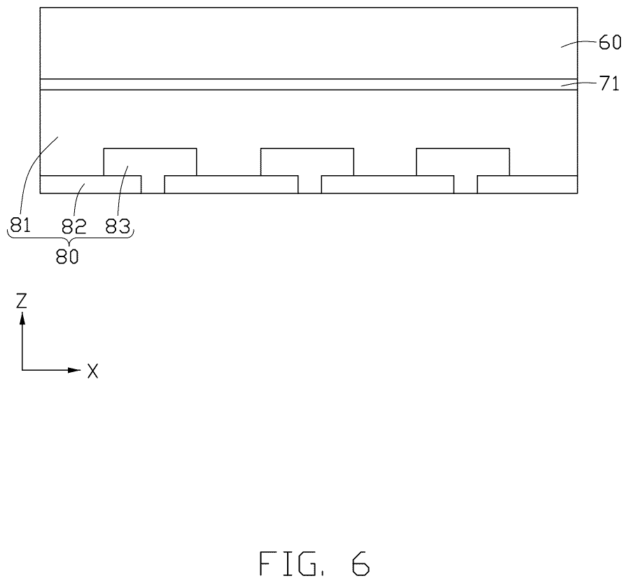

Referring to FIG. 1 and FIG. 6, in one embodiment, the conducting module 5 further includes an eye-tracking assembly 80. The eye-tracking assembly 80 is arranged on a side of the second optical waveguide 60 near the light emitting module 4. The eye-tracking assembly 80 is configured to track positions of eyes. A first adhesive layer 71 is provided between the eye-tracking assembly 80 and the second optical waveguide 60. The first adhesive layer 71 is glued to the eye-tracking assembly 80 and the second optical waveguide 60 by optical glue.

The eye-tracking assembly 80 includes a protective layer 81, a line structure 82, one or more light emitting element 83, and a receiving element. The protective layer 81 is bonded to the second optical waveguide 60 through the first adhesive layer 71. The protective layer 81 is an insulating and transparent material, such as a resin. The line structure 82, the light emitting element 83, and the receiving element are all arranged in the protective layer 81, which are protected by the protective layer 81. The light emitting element 83 and the receiving element are electrically connected to the line structure 82. The light emitting element 83 is a vertical cavity surface emitting laser, the vertical cavity surface emitting laser can emit a tracking laser to the eyeball. The tracking laser is reflected by eyeballs and received by the receiving element to locate positions of the eyeballs. A number of the light emitting element 83 is multiple. Along the second direction X, the multiple light emitting elements 83 are arranged sequentially to improve an accuracy of eye positionings.

The conducting module 5 further includes an electrochromic lens 90. The electrochromic lens 90 is arranged on a side of the second optical waveguide 60 away from the light emitting module 4. A second adhesive layer 72 is provided between the electrochromic lens 90 and the second optical waveguide 60. The second adhesive layer 72 is bonded to the electrochromic lens 90 and the second optical waveguide 60 by optical glue. The electrochromic lens 90 is capable of changing colors to improve an appearance of the display module 100. The electrochromic lens 90 can also change colors according to different light environments, result in improving an adaptability of the display module 100 to an external environment.

The conducting module 5 further includes an ambient light sensor 91. The ambient light sensor 91 is provided on a side of the electrochromic lens 90 away from the second optical waveguide 60. The ambient light sensor 91 is configured to sense a light intensity of an outside environment, so as to adjust the light intensity of the light emitting unit 10 to save energy consumption.

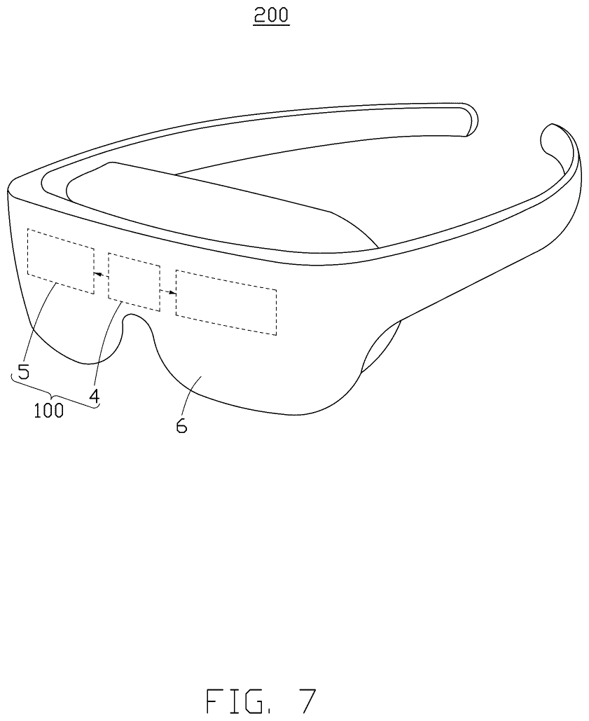

Referring to FIG. 7, a present application embodiment further provides a wearable display device 200. The wearable display device 200 includes an equipment body 6 and the display module 100. The display module 100 is installed in the equipment body 6. The equipment body 6 can be a frame of an AR glasses. The conducting module 5 in the display module 100 is arranged as two, the light emitting module 4 is arranged between the two conducting modules 5. The equipment body 6 may be smart watches, projectors and other electronic devices with imaging functions.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A display module, comprising:
a light emitting module comprising a display assembly, a first optical waveguide, and a polarizer arranged in sequence in a first direction, the light emitting module further comprises a light emitting unit arranged on one side of the first optical waveguide in a second direction, and configured to emit a first light to the first optical waveguide, the second direction intersects the first direction, wherein the first light is transmitted to the display assembly through the first optical waveguide, the display assembly is configured to reflect the first light to form a second light, and the second light passes through the first optical waveguide and the polarizer to form a third light; and
a conducting module, comprising a second optical waveguide arranged on one side of the light emitting module in the first direction, and configured to receive the third light and guide the third light to emit the second optical waveguide.

2. The display module as claimed in claim 1, wherein, the first optical waveguide comprises a first surface and a second surface, the first surface is arranged on a side of the first optical waveguide near the polarizer, the second surface is arranged on a side of the first optical waveguide near the display assembly, the first light is emitted into the first optical waveguide, and is at least partly reflected by the first surface after passing through the second surface.

3. The display module as claimed in claim 2, wherein, the first optical waveguide is provided with a coupled structure and one or more decoupled structure, the coupled structure is arranged on a side of the first optical waveguide near the light emitting unit, the coupled structure is configured such that the first light emitted into the first optical waveguide is totally reflected on the first surface; multiple of the decoupled structures are arranged on the second surface at intervals in the second direction, the decoupled structure is configured to receive the first light after being reflected and guide the first light to the display assembly.

4. The display module as claimed in claim 1, wherein, the third light comprises one or more of red light, green light, and blue light, in the first direction, the second optical waveguide comprises a red waveguide layer, a green waveguide layer, and a blue waveguide layer arranged in sequence, the red waveguide layer is located on a side of the blue waveguide layer near the light emitting module, the red waveguide layer is configured to receive and transmit the red light in the third light; the green light waveguide layer is configured to receive and transmit the green light in the third light, and the blue light waveguide layer is configured to receive and transmit the blue light in the third light.

5. The display module as claimed in claim 1, wherein, in the first direction, the display assembly further comprises a reflective display and a pattern unit arranged in turn; the pattern unit is arranged on one side of the reflective display near the first optical waveguide, the reflective display is configured to reflect the first light to form the second light, and the pattern unit is configured to transmit a portion of the second light.

6. The display module as claimed in claim 1, wherein, the light emitting module further comprises a light adjustment assembly, the light adjustment assembly is arranged between the polarizer and the second optical waveguide, the light adjustment assembly comprises a collimating lens, a light homogenizing lens and a relay lens arranged in turn in the first direction, the collimating lens is arranged on a side of the relay lens near the polarizer.

7. The display module as claimed in claim 6, wherein, the light homogenizing lens comprises a main body and two micro lens structures, the two micro lens structures are separately arranged on two opposite sides of the main body in the first direction, and are distributed in an array on the two sides of the main body.

8. The display module as claimed in claim 1, wherein, the conducting module further comprises an eye-tracking assembly arranged on a side of the second optical waveguide near the light emitting module, the eye-tracking assembly tracks positions of eyes.

9. The display module as claimed in claim 1, wherein, the conducting module further comprises an electrochromic lens arranged on a side of the second optical waveguide away from the light emitting module.

10. A wearable display device, comprising:
an equipment body, and
a display module, installed on the equipment body, wherein
the display module comprises a light emitting module and a conducting module; the light emitting module comprises a display assembly, a first optical waveguide, and a polarizer arranged in sequence in a first direction, the light emitting module further comprises a light emitting unit arranged on one side of the first optical waveguide in a second direction, and configured to emit a first light to the first optical waveguide, the second direction intersects the first direction, wherein the first light is transmitted to the display assembly through the first optical waveguide, the display assembly is configured to reflect the first light to form a second light, and the second light passes through the first optical waveguide and the polarizer to form a third light; the conducting module comprises a second optical waveguide arranged on one side of the light emitting module in the first direction, and configured to receive the third light and guide the third light to emit the second optical waveguide.

11. The wearable display device as claimed in claim 10, wherein, the first optical waveguide comprises a first surface and a second surface, the first surface is arranged on a side of the first optical waveguide near the polarizer, the second surface is arranged on a side of the first optical waveguide near the display assembly, the first light is emitted into the first optical waveguide, and is at least partly reflected by the first surface after passing through the second surface.

12. The wearable display device as claimed in claim 11, wherein, the first optical waveguide is provided with a coupled structure and one or more decoupled structure, the coupled structure is arranged on a side of the first optical waveguide near the light emitting unit, the coupled structure is configured such that the first light emitted into the first optical waveguide is totally reflected on the first surface; multiple of the decoupled structures are arranged on the second surface at intervals in the second direction, the decoupled structure is configured to receive the first light after being reflected and guide the first light to the display assembly.

13. The wearable display device as claimed in claim 10, wherein, the third light comprises one or more of red light, green light, and blue light, in the first direction, the second optical waveguide comprises a red waveguide layer, a green waveguide layer, and a blue waveguide layer arranged in sequence, the red waveguide layer is located on a side of the blue waveguide layer near the light emitting module, the red waveguide layer is configured to receive and transmit the red light in the third light; the green light waveguide layer is configured to receive and transmit the green light in the third light, and the blue light waveguide layer is configured to receive and transmit the blue light in the third light.

14. The wearable display device as claimed in claim 10, wherein, in the first direction, the display assembly further comprises a reflective display and a pattern unit arranged in turn; the pattern unit is arranged on one side of the reflective display near the first optical waveguide, the reflective display is configured to reflect the first light to form the second light, and the pattern unit is configured to transmit a portion of the second light.

15. The wearable display device as claimed in claim 10, wherein, the light emitting module further comprises a light adjustment assembly, the light adjustment assembly is arranged between the polarizer and the second optical waveguide, the light adjustment assembly comprises a collimating lens, a light homogenizing lens and a relay lens arranged in turn in the first direction, the collimating lens is arranged on a side of the relay lens near the polarizer.

16. The wearable display device as claimed in claim 15, wherein, the light homogenizing lens comprises a main body and two micro lens structures, the two micro lens structures are separately arranged on two opposite sides of the main body in the first direction, and are distributed in an array on the two sides of the main body.

17. The wearable display device as claimed in claim 10, wherein, the conducting module further comprises an eye-tracking assembly arranged on a side of the second optical waveguide near the light emitting module, the eye-tracking assembly tracks positions of eyes.

18. The wearable display device as claimed in claim 10, wherein, the conducting module further comprises an electrochromic lens arranged on a side of the second optical waveguide away from the light emitting module.
